(19) United States
(12) Patent Application Publication
(10) Pub. No.: US 2013/0315873 A1
(43) Pub. Date: Nov. 28, 2013

(54) PESTICIDE COMPOSITION FOR SHORTENING THE VIRUS LETHAL TIME

(71) Applicant: NATIONAL TAIWAN UNIVERSITY, Taipei City (TW)

(72) Inventors: Ju-Chun Hsu, Taipei City (TW); Hsiang-Chuan Wang, Taipei City (TW); Cheng-Jen Shih, Taipei City (TW); Shu-Jen Tuan, Taichung City (TW)

(73) Assignee: NATIONAL TAIWAN UNIVERSITY, Taipei City (TW)

(21) Appl. No.: 13/900,097

(22) Filed: May 22, 2013

(30) Foreign Application Priority Data
May 23, 2012 (TW) 101118320

(51) Int. Cl. A01N 63/00; A01N 37/20; A01N 43/40

(52) U.S. Cl. CPC A01N 63/00; A01N 43/40; A01N 37/20
USPC 424/93.6

(57) ABSTRACT

The present invention is related to a pesticide composition for shortening the virus lethal time that comprises 0.01-75% of a ryanodine receptor insecticide or a diamides insecticide and 10⁷-10¹² PIB/ml of baculovirus. The pesticide composition of the present invention can effectively reduce the lethal time to the pest compared to the baculovirus alone, and also can increase the control effect of the pest compared to the same concentration of the insecticide.

### FIELD OF THE INVENTION

The present invention is related to a pesticide composition for pest control of moths, flies and beetles, comprising a ryanodine receptor insecticide or a diamide insecticide and baculovirus.

### BACKGROUND OF THE INVENTION

Pesticides are substances or mixture of substances intended for preventing, destroying, repelling or mitigating any pest. The most common use of pesticides is as plant protection products (also known as crop protection products), which in general protect plants from damaging influences such as weeds, diseases or insects. This use of pesticides is so common that the term “pesticide” is often treated as synonymous with “plant protection product”, although it is in fact a broader term, as pesticides are also used for nonagricultural purposes.

A pesticide is generally a chemical or biological agent (such as a virus, bacterium, antimicrobial or disinfectant) that through its effect deters, incapacitates, kills or otherwise discourages pests. Target pests can include insects, plant pathogens, weeds, mollusks, birds, mammals, fish, nematodes (roundworms), and microbes that destroy property, cause nuisance, spread disease or are vectors for disease. Although there are benefits to the use of pesticides, some also have drawbacks, such as potential toxicity to humans and other animals. According to the Stockholm Convention on Persistent Organic Pollutants, 9 of the 12 most dangerous and persistent organic chemicals are pesticides (J Obstet Gynecol Neonatal Nurs. 2010 January-February; 39(1):10340.).

From the lessons of the adverse side effects of chemical pesticides, the development of new chemical pesticides changes to high selectivity, low toxicity and safety for the environment as the main objective. However, this leads to the increasing of the cost and slowing the controlling effects. Until recently, the advances of the biotechnology and fermentation technology again affect the developing direction of pesticides. Biopesticide is expected to be the future main materials of plant protection.

There are more than 400 registered pesticides in Taiwan, but only about 50 are largely used. Owing to the “resistance” of the pests, many pesticides are abandoned from the registered companies and are not common in the market. In recent years, the introductions of new active ingredients of pesticide are slow and less than 10 are registered each year. Therefore, the pesticides should be used wisely to extend their life and to avoid the rapid existence of the resistance problem. In plant protection industry, it is thought that the rapid expansion of the “resistance” problem is related to the interaction of reagents having similar chemical structures and same mode of action. Rotationally using pesticides with different mode of actions is considered to be the most effective mean to prevent the resistance.

In fact, the development of a pesticide requires the investment of big amount of time and money. Using herbicides as an example, to develop a new herbicide, about 78,000 compounds would be screened, consuming 110 months and cost $ 150 million. So if we can maintain the effectiveness of the pesticides on targeting organisms and reduce the development of the resistance, the cost would be reduced and the environment would be protected.

### BRIEF DESCRIPTION OF THE DRAWINGS

FIG. 1 shows the cumulative death rates for applying 10% of the registered concentration of Chlorantraniliprole, nucleopolyhedrovirus and the mixture of 10% of the registered concentration of Chlorantraniliprole+nucleopolyhedrovirus to the third instar larvae of Spodoptera litura.

FIG. 2 shows the death rates of the third instar larvae of Spodoptera litura treated by seven different concentrations of Chlorantraniliprole mixing with the nucleopolyhedrovirus.

### SUMMARY OF THE INVENTION

The present invention provides a pesticide composition comprising: (a) a ryanodine receptor insecticide or a diamides insecticide and (b) baculovirus, wherein the concentration of the ryanodine receptor insecticide or the diamides insecticide is 0.01-75% and the concentration of the nucleopolyhedrovirus is 10⁷-10¹² PIB/ml.

### DETAIL DESCRIPTION OF THE INVENTION

Unless otherwise specified, “a” or “an” means “one or more”.

The baculoviruses are a family of large rod-shaped viruses that can be divided into two genera: nucleopolyhedroviruses (NPV) and granuloviruses (GV). While GVs contain only one nucleocapsid per envelope, NPVs contain either single (SNPV) or multiple (MNPV) nucleocapsids per envelope. The enveloped virions are further occluded in granulin matrix in GVs and polyhedrin for NPVs. Moreover, GV have only single virion per granulin occlusion body while polyhedra can contain multiple embedded virions.

Baculoviruses have very species-specific tropisms among the invertebrates with over 600 host species that have been described. Immature (larval) forms of moth species are the most common hosts, but these viruses have also been found infecting sawflies, mosquitoes, and shrimp. Although baculoviruses are capable of entering mammalian cells in culture (Proc Natl Acad Sci USA. 1995 Oct. 24; 92(22):10099-103.), they are not known to be capable of replication in mammalian or other vertebrate animal cells. Baculoviruses contain circular double-stranded genome ranging from 80-180 kbp.

The majority of baculoviruses used as biological control agents are in the genus Nucleopolyhedrovirus. These viruses are excellent candidates for species-specific, narrow spectrum insecticidal applications. They have been shown to have no negative impacts on plants, mammals, birds, fish, or even on non-target insects. This is especially desirable when beneficial insects are being conserved to aid in an overall Integrated Pest Management (IPM) program, or when an ecologically sensitive area is being treated. The USDA Forest Service currently uses the gypsy moth nuclear polyhedrosis virus (LdNPV) to aerially spray thousands of acres of forest each year. This product, registered as GYPCHEK, is effective against gypsy moths but leaves all other animals unharmed.

On the other hand, the high specificity of baculoviruses is also cited as a weakness for agricultural uses, since growers may want one product to use against a variety of pests. Currently, researchers are attempting to use genetic engineering techniques to expand virus host ranges to the desired pest species. Releases of such genetically-engineered baculoviruses have been made by researchers in the U.K. and the United States and show promise, although the cost of commercial production of these agents must be reduced if they are to be competitive. Companies like Dupont, biosys, American Cyanamid, and Agrivirion have continued to explore the expansion and development of agricultural-use viral insecticides.

Ryanodine and ryanodol are poisonous alkaloids found in the South American plant Ryania speciosa (Flacourtiaceae). They were originally used as insecticides. The compounds have extremely high affinity to the open-form ryanodine receptor, a group of calcium channels found in skeletal and heart muscle cells. They bind with such high affinity to the receptor that they were used as labels for the first purification of that class of ion channels and gave its name to it.

At nanomolar concentrations, ryanodine locks the receptor in a half-open state, whereas it fully closes them at micromolar concentration. The effect of the nanomolar-level binding is that ryanodine causes release of calcium from calcium stores in the sarcoplasmic reticulum leading to massive muscular contractions. This is true for both mammals and insects.

Ryanodine receptor modulators are a new kind of synthetic pesticide, which is effective to Lepidoptera pests including the European corn borer, sugar cane borer, codling moth, apple borer and gypsy moth. Chlorantraniliprole, flubendiamide and cyantraniliprole have been already registered.

The mixture of pesticides refers to two or more pesticides simultaneously mixed and used at the same time. By reasonably mixing of pesticides, we can expand their targeting scope or control several pests, even increase the efficacy and reduce the side effect such as resistance of the pests or damage to the crop. However, unreasonably mixing of pesticides would reduce the efficacy or produce damages.

The present invention, compared to the prior art, has the following advantages and effects: in the present invention, low concentration of chemical pesticides are mixed with virus. The present invention maintains the biological characteristics of the virus. Because of the concentration of chemical pesticides herein is only 2% of the amount used in the field, the present invention greatly reduces the risk for human and animals exposing to the chemicals, the pesticide residues and shortens the harvest time. The pests do not easily become resistant to the present invention and the present invention maintains long efficacy. The viral pathogenic time can be reduced for more than 2 folds (only two days can reach 50% of death and 3-4 days to 90% of death). The present invention is suitable for crops such as vegetables, soybeans or peanuts and achieves the control effect in the field.

Therefore, the present invention provides a pesticide composition comprising: (a) a ryanodine receptor insecticide or a diamides insecticide and (b) baculovirus, wherein the concentration of the ryanodine receptor insecticide or the diamides insecticide is 0.01-75% and the concentration of the baculovirus is 10⁷-10¹² PIB/ml.

In the preferred embodiment of the present invention, the concentration of the ryanodine receptor insecticide or the diamides insecticide is 0.1-50% and the concentration of the baculovirus is 10⁷-10¹¹ PIB/ml. In the more preferred embodiment of the present invention, the concentration of the ryanodine receptor insecticide or the diamides insecticide is 0.1-40% and the concentration of the baculovirus is 10⁷-10¹⁰ PIB/ml.

The pesticide composition of the present invention, which controls pests of moths, flies or beetles and shortens pesticidal time of the baculovirus to pest by more than two folds.

The pesticide composition of the present invention, which is sprayed directly, seed-treated, distributed in fields or mixed with baits or other attractant substances (Ex. food attractants, semiochemicals or pheromone) after dilution to achieve pesticidal effects. In the preferred embodiment of the present invention, the dilution is 100-3000 folds.

In the preferred embodiment of the present invention, the concentration of the ryanodine receptor insecticide or the diamides insecticide in the fields is 0.1-100 ppm and the concentration of the baculovirus in the fields is 10⁴-10⁹ PIB/ml. In the more preferred embodiment of the present invention, the concentration of the ryanodine receptor insecticide or the diamides insecticide in the fields is 0.5-60 ppm and the concentration of the baculovirus in the fields is 10⁵-10⁹ PIB/ml. In the most preferred embodiment of the present invention, the concentration of the ryanodine receptor insecticide or the diamides insecticide in the fields is 1.2-20 ppm and the concentration of the baculovirus in the fields is 10⁵-10⁸ PIB/ml.

In the preferred embodiment of the present invention, the ryanodine receptor insecticide is chlorantraniliprole, flubendiamide or cyantraniliprole and the baculovirus is nucleopolyhedrovirus.

In the preferred embodiment of the present invention, the concentration of the ryanodine receptor insecticide or the diamides insecticide is 0.01-20% and the concentration of the baculovirus is 10⁷-10¹² PIB/ml. In the more preferred embodiment of the present invention, the concentration of the ryanodine receptor insecticide or the diamides insecticide is 0.1-10% and the concentration of the baculovirus is 10⁷-10¹¹ PIB/ml. In the most preferred embodiment of the present invention, the concentration of the ryanodine receptor insecticide or the diamides insecticide is 0.1-5% and the concentration of the baculovirus is 10⁷-10¹⁰ PIB/ml.

### EXAMPLES

The examples below are non-limiting and are merely representative of various aspects and features of the present invention.

### Formulation

The amount of virus: 10⁸-10¹² PIB/ml
Diamides pesticides (chlorantraniliprole): 0.01-75%
Other components
The application usage: diluting 1000-3000 folds
The amount of virus: 10⁵-10⁹ PIB/ml
Diamides pesticides (chlorantraniliprole): 0.05-75 ppm
Other components

### Example 1

There was no pest control effect when using the low concentrations of the chemical agents of this formulation (for example, 1.47 ppm of Chlorantraniliprole) alone. When treated with 5.5×10⁵ PIB/ml of the Spodoptera litura nucleopolyhedrovirus alone, the 50% lethal time (LT₅₀) of the third instar larvae was 9.2 days. But when treated with the formulation of the present invention, 5.5×1 PIB/ml of the virus and 1.47 ppm of Chlorantraniliprole, the LT₅₀ was shortened to 1-2 days and the 90% of lethal time (LT₉₀) was achieved by 3-4 days (see Table 1).

TABLE 1
The LT₅₀ of Spodoptera litura to the nucleopolyhedrovirus and
low concentration of common pesticides

| | LT₅₀ | 95% fiducial | LT₉₀ | 95% fiducial |
|---|---|---|---|---|
| Treatments | (day) | limits | (day) | limits |
| nucleopolyhedrovirus (NPV) | 9.2 | 8.6-10.1 | 16.2 | 14.0-20.2 |
| nucleopolyhedrovirus + | 4.5 | 3.9-5.1 | 10.3 | 8.9-13.0 |
| 16 ppm Chlorfluazuron | | | | |
| nucleopolyhedrovirus + | 1.7 | 0.4-2.0 | 3.7 | 2.9-6.3 |
| 1.47 ppm Chlorantraniliprole | | | | |

The concentration of the nucleopolyhedrovirus (NPV): 0.5×10⁵ PIB/ml

### Example 2

The mixing of different pesticides caused different effects, such as antagonism or synergism. But even for the synergism, the effects were only up to a maximum of 2 folds (50% of increase), such as the application of the Chlorfluazuron and nucleopolyhedrovirus. Three days after treating with 5.5×10⁵ PIB/ml of Spodoptera litura nucleopolyhedrovirus, the pests did not die. When treated alone with the chemical pesticides such as Chlorfenapyr, Chlorfluazuron, Metaflumizone and Chlorantraniliprole respectively, the 50% lethal concentrations (LC₅₀) were 11.8, 7.48, 32.3 and 1.36 ppm (Table 2). If the chemical pesticides were combined with the virus, only Chlorantraniliprole had the synergistic effects of 4 folds (3 folds of increase) and the other agents such as Metaflumizone had the interfered effects.

TABLE 2
LC₅₀ of Spodoptera litura to the testing pesticides 3 days
after the treatment (treating with 5.5 × 10⁵ PIB/ml of
nucleopolyhedrovirus did not cause the death of pests)

| | | | | synergistic |
|---|---|---|---|---|
| | LC₅₀ | 95% fiducial | Increasing | effects |
| Treatments | (ppm) | limits (ppm) | rate | (fold) |
| Chlorfenapyr | 11.8 | 8.83-15.4 | | |
| nucleopolyhedrovirus + | 10.0 | 5.86-17.9 | 15% | 1.18 |
| Chlorfenapyr | | | | |
| Chlorfluazuron | 7.48 | 5.35-11.0 | | |
| nucleopolyhedrovirus + | 3.07 | 2.18-4.16 | 144% | 2.44 |
| Chlorfluazuron | | | | |
| Metaflumizone | 32.3 | 23.9-42.9 | | |
| nucleopolyhedrovirus + | 44.2 | 34.2-57.5 | −26.9% | 0.73 |
| Metaflumizone | | | | |
| Chlorantraniliprole | 1.36 | 0.913-2.01 | | |
| nucleopolyhedrovirus + | 0.333 | 0.174-0.558 | 308% | 4.08 |
| Chlorantraniliprole | | | | |

Increasing rate: [LC₅₀ of insecticide only − LC₅₀ of (npv + insecticide)]/LC₅₀ of (npv + insecticide)
synergistic effects: LC₅₀ of insecticide only/LC₅₀ of (npv + insecticide)

### Example 3

Although mixing of proper pesticides can achieve synergistic effects, the mixture with current concentration for field application equals to twice the amount of pesticides used (If the viruses or pesticides are originally used individually, the mixture would be the same concentration used together). This does not achieve the purpose of reducing. The content of Chlorantraniliprole used in the present invention (2% of the current registered concentration, 1.47 ppm) was 50 folds lower than the existing application technique. When mixing with Spodoptera litura nucleopolyhedrovirus, the LT₅₀ of the third instar larvae was less than 2 days and the LT₉₀ was only 3-4 days. There was no pest control effects in the field with this low concentration (1.47 ppm) administered alone. However, when mixing the low concentration of Chlorantraniliprole with the virus, only 2% of the current registered amount of Chlorantraniliprole was mixed with the virus, 85-95% of control rate was achieved (Table 3).

TABLE 3
The control rate of Spodoptera litura in Brassica oleracea
crops by treating with nucleopolyhedrovirus and different pesticides
in the field

| | Control rate (%) | | | | |
|---|---|---|---|---|---|
| | | One | One | | |
| | | week | week | Two | |
| | One week | after the | after the | weeks | |
| | after the | second | third | after the | |
| | first | treat- | treat- | third | |
| Treatment | treatment | ment | ment | treatment | mean |
| Chlorfluazuron | −3.2 | −50.3 | 38.6 | 19.2 | 1.0 |
| Chlorantraniliprole | 31.6 | 22.9 | 77.3 | −5 | 32 |
| nucleopolyhedrovirus | 61.3 | 56.9 | 69.3 | −28.8 | 40 |
| Chlorfluazuron + | 76.8 | 69.3 | 67 | 81.8 | 74 |
| nucleopolyhedrovirus | | | | | |
| Chlorantraniliprole + | 73.5 | 84.3 | 93.2 | 87.1 | 85 |
| nucleopolyhedrovirus | | | | | |

The concentration of the Spodoptera litura nucleopolyhedrovirus: 10⁶ PIB/mL; Chiorfluazuron was 5 ppm (20% of the current registered concentration); Chlorantraniliprole was 1.47 ppm (2% of the current registered concentration)

### Example 4

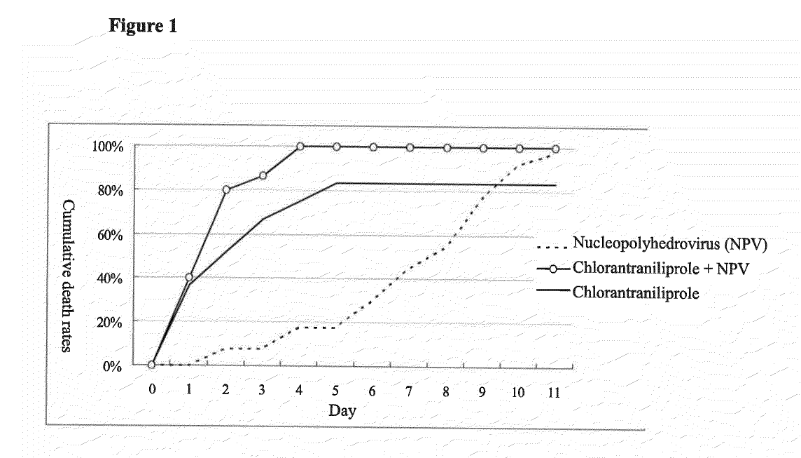

The cumulative death rates of the third instar larvae of Spodoptera litura to 10% of the registered concentration of Chlorantraniliprole (7.36 ppm), nucleopolyhedrovirus (5.5×10⁵ PIB/ml) and the mixture of 10% of the registered concentration of Chlorantraniliprole+nucleopolyhedrovirus were shown in FIG. 1. It cost 11 days for the treatment of nucleopolyhedrovirus alone to achieve 100% of death rate. For the treatment of Chlorantraniliprole alone, only 80% of death rate was achieved. By mixing of both agents, 100% of death rate was achieved in the fourth day.

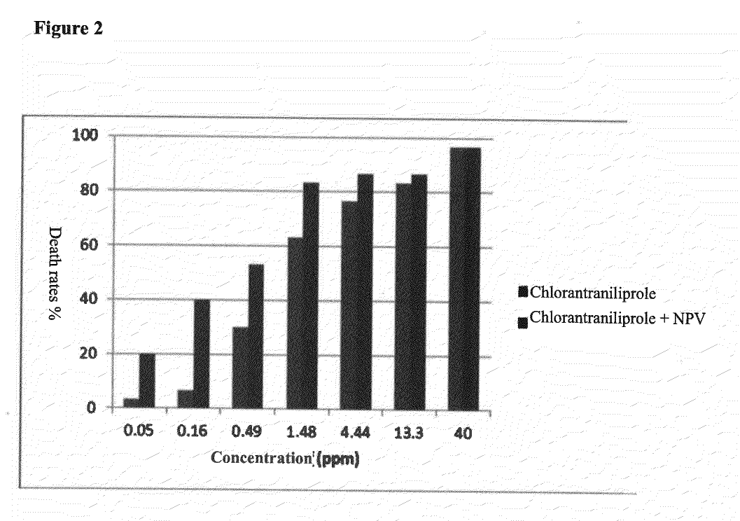

In the indoor experiments, the third instar larvae of Spodoptera litura were treated with the mixtures of seven different concentrations of Chlorantraniliprole with the nucleopolyhedrovirus. Except for 40 ppm of Chlorantraniliprole resulting in 100% of death rate can not discriminate the increasing effect of the mixture, from 0.05 to 13.3 ppm, the effects were better for the mixtures than the Chlorantraniliprole alone, showing the increasing effects. The synergistic effect of the mixture was more significant especially in the comparison of the low death rate caused by the low concentration of Chlorantraniliprole (see FIG. 2). The combination of this formulation was evidenced with the scientific experiments to demonstrate non-obvious effects.

What is claimed is:

1. A pesticide composition comprising: (a) a ryanodine receptor insecticide or a diamides insecticide and (b) baculovirus, wherein the concentration of the ryanodine receptor insecticide or the diamides insecticide is 0.01-75% and the concentration of the baculovirus is 10⁷-10¹² PIB/ml.

2. The pesticide composition of claim 1, wherein the concentration of the ryanodine receptor insecticide or the diamides insecticide is 0.1-50% and the concentration of the baculovirus is 10⁷-10¹¹ PIB/ml.

3. The pesticide composition of claim 1, wherein the concentration of the ryanodine receptor insecticide or the diamides insecticide is 0.1-40% and the concentration of the baculovirus is 10⁷-10¹⁰ PIB/ml.

4. The pesticide composition of claim 1, which controls pests of moths, flies or beetles.

5. The pesticide composition of claim 1, which is sprayed directly, seed-treated, distributed in fields or mixed with baits or other attractant substances after dilution to achieve pesticidal effects.

6. The pesticide composition of claim 5, wherein the dilution is 100-3000 folds.

7. The pesticide composition of claim 1, which shortens pesticidal time of the baculovirus to pest by more than two folds.

8. The pesticide composition of claim 1, wherein the ryanodine receptor insecticide is chlorantraniliprole, flubendiamide or cyantraniliprole.

9. The pesticide composition of claim 1, wherein the baculovirus is nucleopolyhedrovirus.

10. The pesticide composition of claim 1, wherein the concentration of the ryanodine receptor insecticide or the diamides insecticide is 0.01-20% and the concentration of the baculovirus is 10⁷-10¹² PIB/ml.

11. The pesticide composition of claim 1, wherein the concentration of the ryanodine receptor insecticide or the diamides insecticide is 0.1-10% and the concentration of the baculovirus is 10⁷-10¹¹ PIB/ml.

12. The pesticide composition of claim 1, wherein the concentration of the ryanodine receptor insecticide or the diamides insecticide is 0.1-5% and the concentration of the baculovirus is 10⁷-10¹⁰ PIB/ml.
